(19) United States
(12) Patent Application Publication
(10) Pub. No.: US 2009/0238548 A1
(43) Pub. Date: Sep. 24, 2009

(54) Method and apparatus for elliciting attention for photography

(76) Inventors: Scot Michael Smith, San Mateo, CA (US); Jason Edward Richie, San Francisco, CA (US)

Correspondence Address: Scot Smith, 2660 Flores ST. # 5, San Mateo, CA, 94403, US

(21) Appl. No.: 12/077,403

(22) Filed: Mar. 18, 2008

(51) Int. Cl. G03B 15/00

(52) U.S. Cl. 396/5

(57) ABSTRACT

A method for the challenging problem of eliciting the attention of dynamic subjects such as small children for the purposes of photography is disclosed herein. Specifically, we disclose an inexpensive, quickly deployable, and flexible device that can be used with a wide variety of recording devices available on the market. One embodiment of the invention discloses an attachment that can engage with the threaded tripod mount hole that is found as a feature on most current modern cameras, allowing an attention-attracting object, such as a child's toy, to be suspended from a camera, thereby allowing the photographer to elicit the gaze and attention of the subject and operate the camera with both hands, which provides considerable stability. Another embodiment of the invention discloses a re-attachment means for the attention-eliciting device, allowing the photographer to quickly swap the attention-attracting object and customize it to the situation and subject.

### FEDERALLY SPONSORED RESEARCH

Not applicable

### SEQUENCE LISTING OR PROGRAM

Not applicable

### FIELD OF THE INVENTION

The present invention relates in general to tools and methods for photography of living subjects. In particular, the present invention relates to tools and methods for eliciting the subject's attention and gaze for purposes of photography.

### BACKGROUND OF THE INVENTION

Photography is a broad art that refers generally to using a camera to capture images of the world. In many cases, the subjects of the photography are dynamic entities such as humans and animals, which present certain challenges to the craft of photography. These challenges include capturing the images of the subjects at the appropriate moments in time and minimizing movements within the scene to prevent undesirable artifacts in the resultant photo, such as blurriness. Blurriness results when there is motion in the captured scene that occurs while the camera's shutter is open.

In the special case of photographing dynamic entities such as humans and animals, it is many times desirable to capture the living subjects in a pose where unique aspects of the subject, such as facial features, are visible to the camera's field of view. Additionally, it is also often desirable for the resultant photo to convey the subject's emotional state, such as happiness or surprise.

As evidence of the level of skill and training necessary to capture photographs of dynamic scenes, an entire field of professional portrait photography has developed in order to provide access to specialized equipment and expertise. It is common for any type of photography in which human subjects are involved to communicate and instruct the subject to look into the camera in a certain manner, or to instruct the subject to pose in a certain manner. However, this method of communicating verbal instructions to the subject of the photography is not possible when the subject is not capable of understanding language, such as in cases where the subject or subjects are small children or animals. Additionally, verbal communication is not always possible in environments where loud ambient noise is present; such noisy environments causing the verbal commands to be indiscernible even among subjects that can understand language.

Much effort and investment has thus been attempted to solve the problem of photographing infants in order to produce desirable photos. One common approach to orienting the subject of the photography towards the camera is to physically constrain the subject such that movements that disorient the subject from the camera are not possible. For example, U.S. Pat. No. 2,646,735, entitled “Baby Poser”, teaches a full-body apparatus that can be used to constrain a small child into a fixed position, thereby allowing the photographer enough time to capture the child in this position on camera.

While these techniques do result in images where by the subject is oriented towards the camera, they have many undesirable features. Firstly, devices that physically limit movement are uncomfortable to the subject, potentially causing the subject to display displeasure. For infants, such constraining devices may even be dangerous, restricting respiration or cutting off circulation to the limbs. Full-body apparatuses are also costly to purchase and inconvenient, for example when outdoors or traveling.

Another approach to solving the current problem is to modify the surrounding environment instead of modifying the subject, with the goal of eliciting a desirable pose by attracting the interest of the subject towards a certain direction. Many professional portrait photographers commonly conduct their photography inside a dedicated studio. U.S. Pat. No. 3,812,506, entitled “System for Child Photography”, teaches a system whereby the camera and the subject are at fixed locations in space, where the camera is supported in space by a tripod mounted to the camera A video screen is then placed above and behind the camera, along the axis of the subject and camera, such that the camera is between the subject and the screen. Images or movies are then displayed on the screen in order to elicit the interest of the subject. Thus images captured by the camera will display the subject orienting in the general direction of the camera in the horizontal plane. While this “specialized studio” approach encourages the subject to orient towards the camera in the horizontal plane without requiring physical constraints on the subject, it is costly to implement and prohibitive in many photographic situations. Not only is there substantial cost in obtaining a specialized studio setup with a video display, there is no guarantee that the movie that is shown is attractive of the subject's attention, nor that it will elicit the desired emotional response from the subject by the photographer. Also, images of the subject captured by this setup may have the subject's gaze directed upwards or off of the central axis as that is the only configuration in which the camera and photographer are not blocking the view of the subject towards the screen. A specialized studio setup also is not portable in the sense that it limits the photography to the place of the specialized studio setup, which is typically indoors.

It is preferable to have portable techniques for eliciting the subject's interest that do not restrict the location of the photography. Flash is typically used to provide illumination of the subject at the point of capture in situations that have dark ambient lighting. However U.S. Pat. No. 5,051,763, entitled “Camera with Orienting Flash”, teaches us that flash can also be used to capture the subject's attention. They describe a modified camera that flashes twice; once to draw attention to the camera and the second time to provide the illumination for the actual capture, which would coincide with the second flash. While providing a portable solution for attracting the interest of the subject in photography, this method is not viable in most situations because having flash illumination is not appropriate for every shot, since it alters the lighting condition of the photograph, thereby restricting the technique that the photographer can use. When flash is used inappropriately in photography, it results in a photo that has undesirable artifacts such as bright spots, or over-darkening of the background. Furthermore, flash photography is distinctly not permitted in many settings such as performing arts venues and in certain museums. Additionally, this method is costly since it requires either purchasing a specialized camera or adding custom electronics to an existing camera. A second flash for the purpose of attracting also consumes more power than the standard operation of a camera.

Another method described in U.S. Pat. No. 5,991,547, entitled “Attention Attractor for Viewing Device”, teaches using a die cut cardboard cutout to surround the camera housing. The cardboard surface contains artwork, such that when the cardboard cutout is folded in a certain manner to enclose the camera, it creates the appearance of a cartoon character on the camera, thus providing a means to attract the attention of the child subject. However, this method is impractical for broad application, since the specialized cardboard cutouts would have to be created for each of the multitude of camera housing designs and dimensions. Additionally, the cardboard facade is not durable to weather nor is its appearance desirable over the camera's original design on a permanent basis.

Because of the aforementioned disadvantages and costs associated with the various attempts described above, in practice many casual and professional photographers resort to simpler methods for eliciting the subject's attention, such by manually holding an attention-attracting object in proximity to the capturing camera.

FIG. 1 illustrates such a technique. FIG. 1 depicts a typical photography situation, containing a subject 102, a camera 104, and a photographer 106 operating the camera 104. In this case, the photographer 106 elicits the attention of the subject 102, by holding an attention-attracting object (the “toy”) 108 in a first hand, and operating the camera with a second hand. In this case, the camera is free-standing, and thus the first hand of the photographer 106 used to operate the camera 104 also provides support for the camera.

While the above described technique is a prevalent mode of photography when capturing pictures of young children, it has many disadvantages that cause the above technique to produce resultant photographs that have undesirable features. Since the second hand of the photographer 106 is used to hold the toy 108, necessarily only one hand is available for the operation of the camera 104. Using one hand to operate a camera results in significantly less stability of a camera at the point in time the picture is taken. This is because the act of pressing the shutter control of a camera necessarily causes minute movements of the camera if not properly stabilized by some other means. Stability is of primary importance in photography since any movement of the camera that occurs relative to the scene during the time that the shutter is active results in undesired blurriness in the produced picture.

Thus for photography, and especially in the case of handheld photography, it is of vital importance that the camera is stabilized in some manner, such as by holding the camera with both hands. Therefore, it is highly desirable to have a simple and convenient method for low-cost, portable photography of dynamic subjects that allows for two-handed operation and is effective in eliciting a desirable pose from the subject.

### SUMMARY OF THE INVENTION

A simple, low-cost, and flexible method for portable photography of dynamic subjects is disclosed. The disclosed methods and apparatuses apply to video recording as well as image recording. A method for the challenging problem of eliciting the attention of dynamic subjects such as small children for the purposes of photography is disclosed herein. One embodiment of the invention discloses an attachment that can engage with the threaded tripod mount hole that is found as a feature on most current modern cameras, allowing an attention-attracting object, such as a child's toy, to be suspended from a camera, thereby allowing the photographer to elicit the gaze and attention of the subject and operate the camera with both hands, which provides considerable stability. Another embodiment of the invention discloses a re-attachment means for the attention-eliciting device, allowing the photographer to quickly swap the attention-attracting object and customize it to the situation and subject.

### BRIEF DESCRIPTION OF THE DRAWINGS

The present invention may be further understood from the following description in conjunction with the appended drawings. In the drawings:

FIG. 1 illustrates a method for photographing dynamic subjects whereby the photographer photographs a subject using a camera, said photographer using a first hand to draw the attention of the subject using a attention-eliciting object and a second hand to operate the camera;

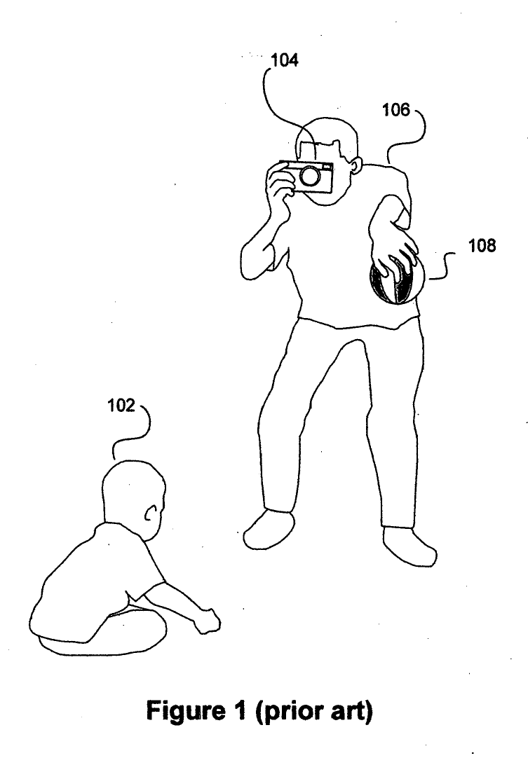

FIG. 2 is a frontal view of an attention eliciting device;

FIG. 3 is a perspective view diagram containing a camera with a tripod mount, and an attention-eliciting device;

FIG. 4 is a simplified drawing of an attention eliciting device with magnetic detachable component;

FIG. 5 is a cutaway perspective view of an attention attractor connector attachment with enclosed magnetic component;

FIG. 6 is a simplified view diagram of an attention attractor with a hook end;

FIG. 7 illustrates a method for photographing dynamic subjects whereby the photographer photographs a subject using a camera, said photographer operating the camera using both of photographer's hands, and an attention-eliciting object attached to the camera; and

FIG. 8 is a flowchart depicting the steps of a method of photography using the attention-eliciting device.

### DETAILED DESCRIPTION

An improved system for the elicitation of attention from dynamic subjects for the purposes of photography is disclosed. The techniques and systems disclosed herein are understood to be universally applicable to both photo and moving picture (video) recording.

As previously described, attraction of the subject's attention via non-language means is necessary in many cases when the subjects of the photography are small children or animals that do not comprehend language. Attracting the attention, and hence including a desirable facial and bodily orientation, are especially desirable for the practice of photography, where movement can cause undesirable artifacts, such as blurriness, in the scene. Additionally, for general purpose photography, amenable to use by a typical consumer, such a system must be low-cost, portable, quick and convenient, among other desirable attributes. A simple and convenient solution that meets these requirements is disclosed below.

A prominent and continuing trend of modern, off-the-shelf, cameras is the existence of several standardized interfaces and components. The standardization of many camera components and connections, such as film types, lens attachment sizes, data buses, and memory cards allows for easy interchange between cameras and a sizeable aftermarket for camera parts. One particular camera interface that is nearly universal on all modern cameras or camcorders, whether the camera employs film or digital media, is a threaded tripod mount. Typically the tripod mount is located at the bottom of the camera or camcorder and is intended to be used as a means to affix the camera to a stable object, such as a three-legged stand resting on the ground. The threaded tripod mount hole is commonly found in standardized dimensions, such as ¼ inch diameter.

A new, originally unintended, use of the tripod mount hole is disclosed. Namely, that the tripod mount hole can be used as an attachment point for an attention-eliciting device.

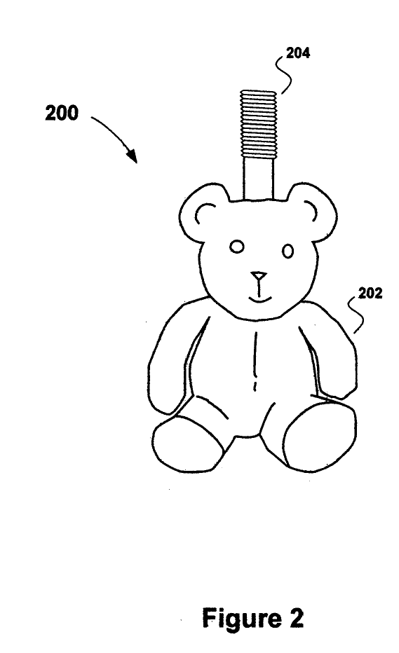

FIG. 2 illustrates an embodiment of such an attention-eliciting device 200. The attention-eliciting device 200 comprises an attention attracting end 202 and a threaded fastener end 204. The attention attracting end 202 functions to draw the attention of the subject towards it. This is not restricted to any particular means, but may take the form of any of the various designs used to attract attention. For small children, this may be in the form of the child's favorite plush toy, brightly colored ball, picture of a cartoon character, etc. The attention attracting object may employ additional and multiple means of attracting attention beyond the visual appearance of the object itself, such as by employing sound, or light. In an embodiment of the invention, the attention attracting component may be a squeaking ball, using sound to attract a small child's gaze. In another embodiment of the invention the attention attracting component may be a figurine with a blinking light emitting diode (LED). In another embodiment of the invention the attention attracting means may be a biscuit used to lure the attention of a pet dog. Various embodiments of attention attracting means are possible and can be selected based on the expression that is desired to be elicited from the subject of the photography.

At the longitudinally opposing end of the attention-eliciting device 200 is the threaded fastener attachment end 204. The threaded fastener attachment end 204 comprises an externally threaded shaft made of hard material that can be used to firmly affix the attention eliciting device 200 to a camera. The diameter size of the threaded fastener attachment end is such that it can be screwed onto a threaded camera tripod mount hole thereby securing the attention attracting object to the camera. Typically, the thread dimension and diameter of the attachment are standardized, so that the device 200 will attach to most nearly any camera or camcorder, and will not need to be customized for each specific camera or camcorder model.

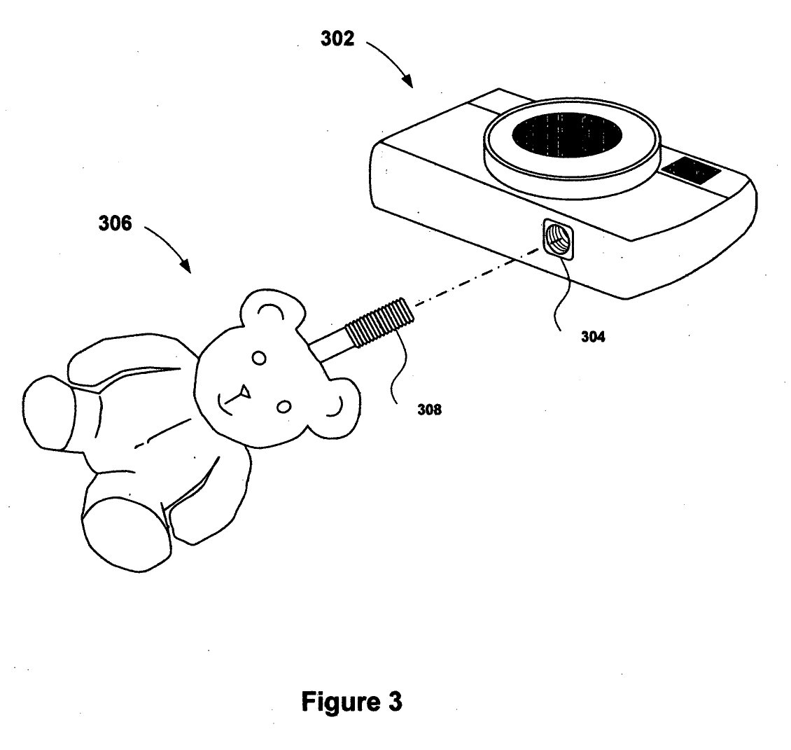

FIG. 3 illustrates a perspective view of a camera 302 with tripod mount hole 304 and attention eliciting device 306. As shown in the figure, the threaded screw end 308 of the attention eliciting device 306 attaches to the tripod mount hole 304 of the camera 302. This act of attachment is typically achieved by placing the threaded screw end 308 of the attention eliciting device 306 against the opening of the camera mount hole 304, such that the major longitudinal axes of the attention eliciting device 306 and the camera mount hole 304 are aligned, as shown. Then, simply rotating the attention eliciting device 306 along the longitudinal axis until the screw stops will attach it.

As noted above, sometimes it is preferable to have different attention-attracting objects, depending on the specific preferences of the subject and the desired expression on the subject to be elicited. It is beneficial to be able to change the attention attracting object to something different and would be desirable that such changing can be performed quickly, as to not lose the attention of the subject.

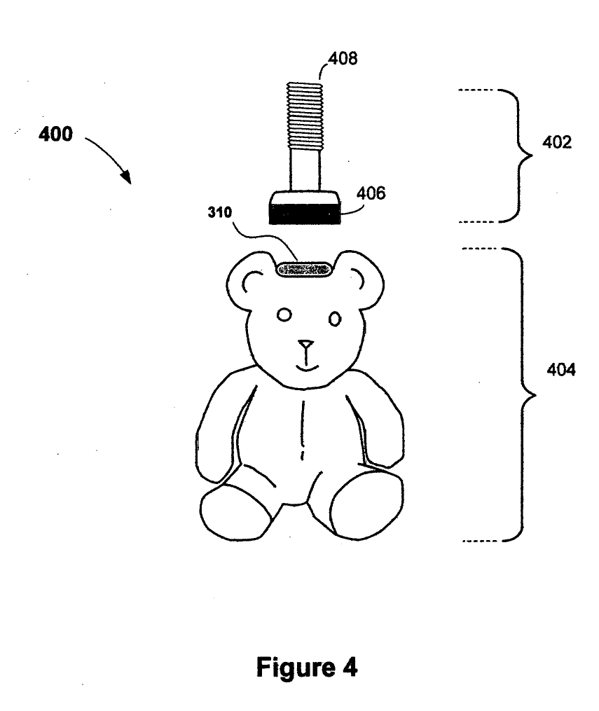

FIG. 4 shows a simplified diagram of an alternative embodiment of the invention. In this figure, the magnetically detachable attention eliciting device 400 comprises two major sections that can be detached from each other. The two major sections are the attachment connector 402, and the attention eliciting object 404. The attachment connector 404 is a rod-shaped device, itself with two major components. At one end is the threaded fastener attachment 408, which is used to attach the attachment converter 404 to the tripod mount hole of the camera in a manner previously described. The opposite end of the attachment connector contains a small magnetic element 406. The small magnetic element can be a common grade magnet that is sufficiently strong enough to support the hanging weight of an object capable of being held by a person. In an exemplary embodiment, the attachment connector 402 can be constructed by gluing an appropriately sized flat headed screw to a small disk-shaped magnetic component.

The second section, the attention eliciting object 404 may take the form of any attention-attracting means previously discussed, including the use of light and sound, additionally containing a magnetically attractive metal or magnetic component 410. The attachment connector 402 and the attention eliciting object 404 interact via the magnetic force of the magnetic component of the attachment connector 402 upon the metal portion of the attention attracting object 404, thus affixing the two together.

This magnetic means of attachment allows the attention eliciting object 404 component of the device 400 to be easily removable, allowing the attachment connector 402 to remain embedded in the camera mount hole while a second attention attracting object is swapped in. Thus this mechanism allows for a variety of attention attracting objects to be used with a single connector attachment 402 as long as attention attracting object contains a metallic portion which is attractive to the magnetic component. This metallic portion can either be intrinsic to the object, such as when the object is composed primarily of metal, or be a small metal portion that is attached to a non-metallic object. In one embodiment of the invention the attention-attracting object is a plush toy that has a disk-shaped metal button sewn onto the plush toy.

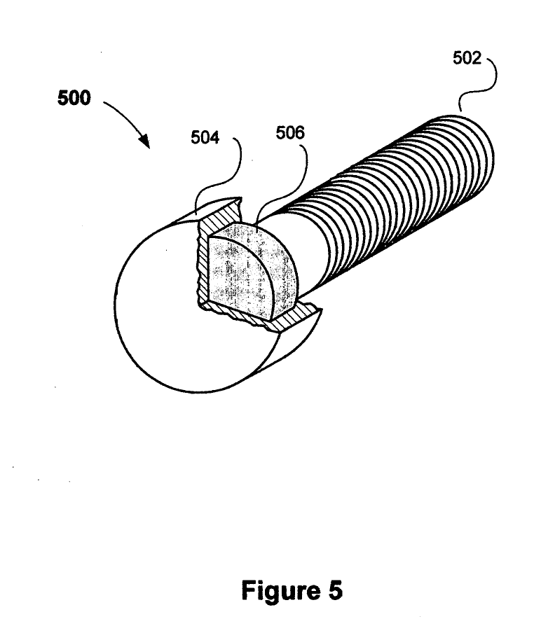

While the connector attachment has been described above as having one end that is a magnetic component, the end that is longitudinally opposite to the threaded screw end need not be wholly magnetic. FIG. 5 displays a cut-away perspective view of an alternative embodiment of the invention whereby the external appearance of a plastic connector attachment 500 has no visible seams. The connector attachment 500 of FIG. 5 comprises a hard plastic object molded into the shape of a threaded bolt fastener, of an appropriate size for attaching into a threaded camera mount hole. The connector attachment 500 comprises one threaded shaft end 502 and an opposite head end 504. The plastic exterior of the head end 504 envelops an interior portion that contains a magnetic element 506, shown as shaded gray in the figure. Thus the magnetic element 506 is completely encased in the plastic, with magnetic element 506 not visible from the exterior. With a sufficiently strong magnetic element 506, connector attachment 500 can operate in like manner to the previous embodiment, with the internal magnetic element 506 attracting the metallic portion of an attention-attracting object.

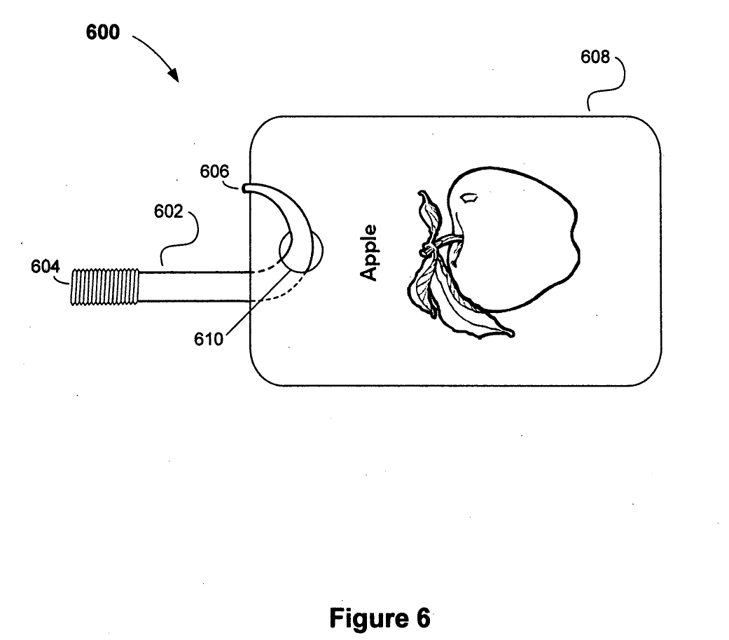

For some candidate attention-eliciting objects, they will not contain, or be amenable to being modified with a metallic portion. FIG. 6 shows an alternative attention-eliciting device 600 having connector attachment 602, which functions similarly as above to connect a camera to an attention-eliciting object. In this embodiment of the invention, one end of the connector attachment 602 is a threaded shaft end 604 and the opposite end of the connector attachment 602 is a hook end 606. In this case, the entire connector attachment 602 may be shaped from a uniform material such as hard plastic, metal, or wood.

A hook-based attachment means is the preferable embodiment for certain types of attention-eliciting objects. For example, if the attention-eliciting object is an illustration or language printed unto cardstock or paper, then a hook can provide an easily removable mechanism for swapping a selection of a multitude of cards. In the embodiment of FIG. 6, the attention-eliciting object component 608 of the device is a card with a drawing of an attention-attracting illustration drawn upon it. The card 608 contains a hole 610, which lets the card hang from the hook end 606 of the connector attachment 602 without occluding the view of the card 608 from the subject.

Operation of Attention-Eliciting Device

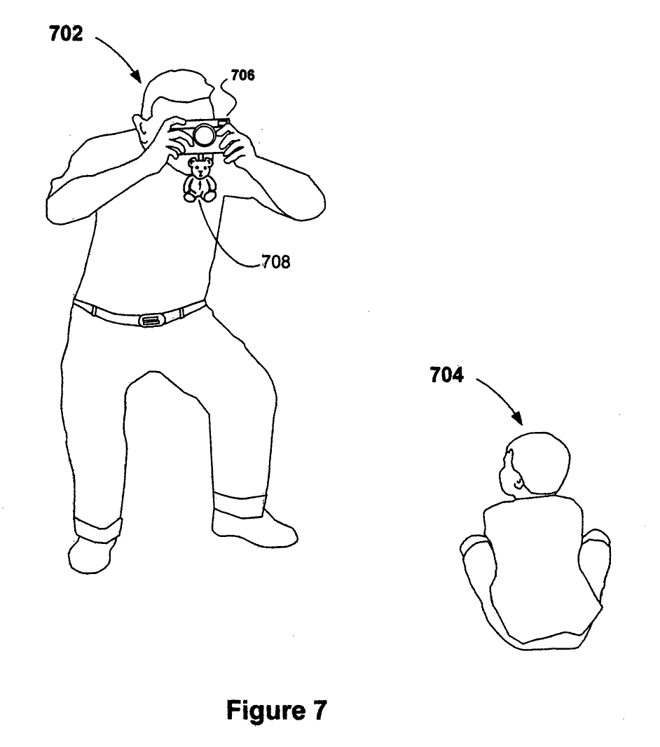

As we have provided in the above a detailed disclosure of the attention-eliciting device and some various embodiments, we now describe methods for operating the device in typical photography situations. FIG. 7 shows a drawing of a typical photography setting involving a photographer 702, a small child subject 704, and a camera 706 employing an attached attention-eliciting device 708 for photography.

In this illustration, the photographer 702 has mounted an attention-eliciting device 708 to the tripod mounting hole of the camera 706 and is in the act of taking a picture with the camera 706. Notably, the attention-eliciting device 708 attracts the attention of the small child subject 704, causing the child 704 to orient his body and face in the general direction of the camera to look at the attention-eliciting device 708 with a joyful expression. Simultaneously, since the attention-eliciting device 708 is attached directly to the camera 706, the photographer 702 is thus able to place both of the photographer's 702 hands firmly on the camera 706. This allows the photographer 702 to provide additional stability to the camera 706, which improves the visual quality of the resultant developed photograph by avoiding blurriness.

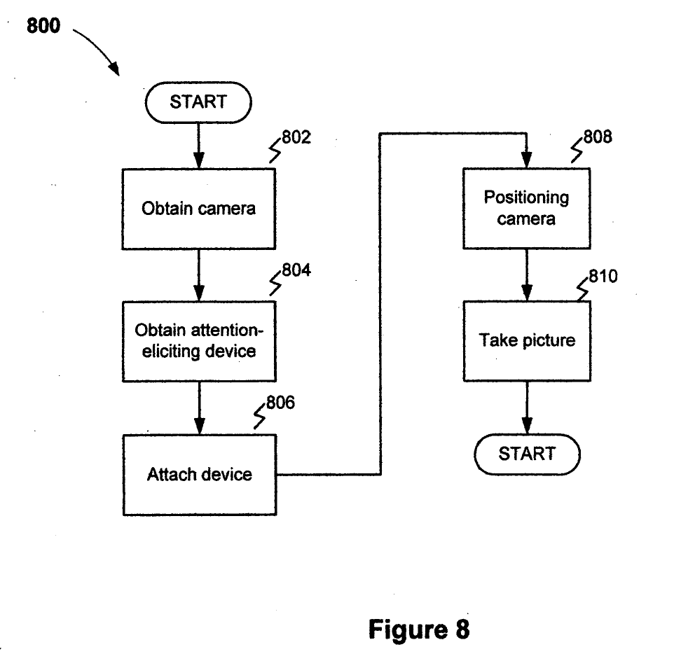

FIG. 8 is a flowchart diagram 800 illustrating the steps for operating an attention-eliciting device. In the first step 802, one obtains a photo or video recording device. Such device must have a tripod mount hole as described in the previous description. Secondly, one obtains 804 an embodiment of an attention-eliciting device that is attractive to the subject and which will elicit the desired response. Then, one attaches 806 the attention-eliciting device of step 804 to the tripod mount hole of the camera obtained in step 802. Typically, the tripod mount hole is located on the bottom side of the camera. Attaching the attention-eliciting device to the camera mount hole comprises placing the threaded screw end of the attention-eliciting device against the opening of the tripod mount hole and rotating the device along the longitudinal axis in the direction necessary to advance the threaded screw end fully into the hole. After the attention-eliciting device has been attached the camera, then the camera or camcorder is pointed 808 at the subject of the photography. This will cause the subject of the photography to look towards the camera and attention-eliciting device combination. The next step 810 would then be to take the picture at the point in time of a desirable pose. The specific act for taking a picture will vary depending on the model of the camera or camcorder but may involve such steps as powering-on the camera, placing the camera in “record” mode, and depressing a shutter or record button.

While the above is a complete description of the preferred embodiments of the invention sufficiently detailed to enable those skilled in the art to build and implement the system, it should be understood that various changes, substitutions, and alterations may be made without departing from the spirit and scope of the invention as defined by the appended claims. For example, in the embodiments described above that contain an attention-attracting object that is detachable from the device, it is understood that the choice of the attention-attracting object can be adapted to the subject depending on the subject's preferences, the desired emotion to be elicited from the subject, and suitable to the setting of the photography. Additionally, the attention-attracting object may be of various forms such as any manner of toy, light stimulus, sound stimulus, or food stimulus.

What is claimed:

1. An attention-eliciting device comprising:
a connector attachment, the connector attachment comprising threaded insertion end; and
an attention-attracting object
wherein said threaded insertion end of connector attachment is capable of engaging with the threaded tripod mount hole of an image recording device.

2. The attention-eliciting device of claim 1 wherein the attention-attracting object emits sound in order to draw attention towards said attention-attracting object.

3. The attention-eliciting device of claim 2 wherein the attention-attracting object emits pulses of light in order to draw attention towards said attention-attracting object.

4. The attention-eliciting device of claim 1 wherein the attention-attracting object is removable and re-attachable from the connector attachment, allowing for the replacement of the attention-attracting object with alternate attention-attracting objects.

5. The attention-eliciting device of claim 4 wherein the connector attachment further comprises a hook end, opposite to the threaded insertion end.

6. The attention-eliciting device of claim 4 wherein the connector attachment further comprises a magnetic element and the re-attachable attention-attracting object further comprises a magnetically-attractive component such as a metallic or magnetic element.

7. A method of photography of a dynamic subject comprising:
obtaining an image recording device with a threaded tripod mount hole;
obtaining an attention-eliciting device;
attaching said attention-eliciting device by engaging the threaded end of the connector attachment with the threaded tripod mount hole of the image recording device;
positioning the camera such that the now attached attention-eliciting device is suspended from the camera and oriented towards the dynamic subject; and
capturing an image with the image recording device.

8. The method of claim 7 further comprising the steps of attaching a suitably configured attention-attracting object to the connector attachment.
